(19) United States
(12) Patent Application Publication
(10) Pub. No.: US 2026/0106337 A1
(43) Pub. Date: Apr. 16, 2026

(54) RECHARGEABLE BATTERY AND RECHARGEABLE BATTERY MODULE INCLUDING THE SAME

(71) Applicant: Samsung SDI Co., Ltd., Yongin-si (KR)

(72) Inventor: Sung Koo Kang, Suwon-si (KR)

(73) Assignee: Samsung SDI Co., Ltd., Yongin-si (KR)

(21) Appl. No.: 19/357,576

(22) Filed: Oct. 14, 2025

(30) Foreign Application Priority Data
Oct. 15, 2024 (KR) 10-2024-0139913

(51) Int. Cl. H01M 50/516; H01M 10/42; H01M 50/209; H01M 50/503; H01M 50/522; H01M 50/526

(52) U.S. Cl. CPC H01M 50/516; H01M 10/425; H01M 50/209; H01M 50/503; H01M 50/522; H01M 50/526

(57) ABSTRACT

The present disclosure relates to rechargeable batteries and a rechargeable battery module including the same. The rechargeable battery module includes rechargeable batteries that are electrically connected without using a busbar. A rechargeable battery module includes a first rechargeable battery including a first electrode terminal and a second rechargeable battery including a second electrode terminal and disposed adjacent to the first rechargeable battery, wherein the first electrode terminal and the second electrode terminal are coupled through at least a contact portion at which an outer surface of the first electrode terminal facing the second electrode terminal is in contact with an outer surface of the second electrode terminal facing the first electrode terminal.

### CROSS-REFERENCE TO RELATED APPLICATIONS

This present application claims priority to and the benefit of Korean Patent Application No. 10-2024-0139913, filed on Oct. 15, 2024 in the Korean Intellectual Property Office, the entire disclosure of which is incorporated herein by reference.

### FIELD

The present disclosure relates to a rechargeable battery and a rechargeable battery module including a plurality of rechargeable batteries.

### BACKGROUND

Rechargeable batteries are capable of being charged and discharged repeatedly unlike primary batteries that cannot be recharged. Low-capacity rechargeable batteries are used in small portable electronic devices, such as smart phones, feature phones, notebook computers, digital cameras, and camcorders, while large-capacity rechargeable batteries are widely used as power sources for driving motors of hybrid vehicles or electric vehicles and used as power storages. A rechargeable battery generally includes electrodes including a positive electrode and/or a negative electrode, an electrode assembly including the electrodes, a case for accommodating the electrode assembly, electrode terminals connected to the electrode assembly, etc.

Along with the development of technologies, high-capacity rechargeable batteries are being required. Accordingly, a plurality of rechargeable batteries may be used by being electrically connected. For example, the rechargeable battery may be applied to an electronic device in the form of a rechargeable battery module including a plurality of rechargeable batteries and/or a rechargeable battery pack including a plurality of rechargeable battery modules. A rechargeable battery pack may be composed of a plurality of rechargeable batteries. In this case, the electronic device is an electronic device requiring high output and/or high capacity, such as electric vehicles.

The plurality of rechargeable batteries constituting the rechargeable battery module or the rechargeable battery pack are electrically connected. For example, electrode terminals of neighboring rechargeable batteries may be connected using a busbar so that the rechargeable batteries may be connected in series or in parallel.

The above information disclosed in this Background section is for enhancement of understanding of the background of the present disclosure, and therefore, it may contain information that does not constitute related or prior art.

### SUMMARY

Aspects of embodiments of the present disclosure provide a rechargeable battery and a rechargeable battery module, allowing rechargeable batteries to be electrically connected without using a busbar.

However, objects of the present disclosure are not limited to the above-described objects, and other objects that are not specifically mentioned herein will be clearly understood by those skilled in the art based on the description of the present disclosure below.

A rechargeable battery module according to some embodiments of the present disclosure includes a first rechargeable battery including a first electrode terminal, and a second rechargeable battery including a second electrode terminal and disposed adjacent to the first rechargeable battery. The first electrode terminal and the second electrode terminal are coupled through at least a contact portion at which an outer surface of the first electrode terminal facing the second electrode terminal is in contact with an outer surface of the second electrode terminal facing the first electrode terminal.

The first electrode terminal and the second electrode terminal may be bonded by welding at the contact portion. At the contact portion, a part or entirety of an outer line of the contact portion is bonded by line welding or a contact surface of the contact portion is bonded by surface welding.

The first electrode terminal may have a first shape, the second electrode terminal may have a second shape complementary to the first shape, and the first shape and the second shape may be coupled to form a connecting structure including the contact portion. The first shape may include a groove recessed in a portion of the outer surface of the first electrode terminal, the second shape may include a protrusion protruding from a portion of the outer surface of the second electrode terminal, and the connecting structure may be formed by inserting the protrusion into the groove.

A plating layer may be further disposed on at least a portion of a contact interface of the protrusion and the groove. The plating layer may be formed of a material having a lower hardness than the first electrode terminal and the second electrode terminal. The first electrode terminal and the second electrode terminal may be formed of one of copper and aluminum or a combination thereof, and the plating layer may be formed of one of copper, gold, and silver or a combination thereof.

The protrusion and the groove may respectively be provided as one protrusion and one groove or two or more protrusions and two or more grooves. The protrusion and the groove may be respectively provided as four or more protrusions and four or more grooves, and the protrusions and the grooves may be disposed in a lattice form.

The first electrode terminal may be fixed to an upper surface of a first case that accommodates an electrode assembly of the first rechargeable battery and protrudes to one side, the second electrode terminal may be fixed to an upper surface of a second case that accommodates an electrode assembly of the second rechargeable battery and protrudes to one side, and protruding portions of the first electrode terminal and the second electrode terminal may be coupled.

The rechargeable battery module may further include a protection circuit module that detects states of the first rechargeable battery and the second rechargeable battery, and a connecting portion provided on at least one of the first electrode terminal and the second electrode terminal and electrically connected to the protection circuit module.

The first rechargeable battery may further include a third electrode terminal, and the rechargeable battery module may further include a third rechargeable battery disposed in a different direction from an arrangement direction of the first rechargeable battery and the second rechargeable battery and including a fourth electrode terminal, and a partial busbar electrically connecting the third electrode terminal to the fourth electrode terminal.

A rechargeable battery according to some embodiments of the present disclosure includes an electrode assembly, a case having a rectangular parallelepiped shape, which accommodates the electrode assembly, and a pair of terminals electrically connected to the electrode assembly and installed on an outer surface of the case so that portions thereof protrude from the case. The pair of terminals may include a first electrode terminal having a first shape and a second electrode terminal having a second shape complementary to the first shape, and the first electrode terminal and the second electrode terminal may each be installed at opposite sides of the outer surface of the case.

The first shape may include a protrusion protruding from a portion of an outer surface of the first electrode terminal, the second shape may include a groove recessed in a portion of an outer surface of the second electrode terminal, and the protrusion may form a connecting structure by being inserted into a groove of a rechargeable battery disposed adjacent to the rechargeable battery. The rechargeable battery may further include a plating layer formed on at least one of an outer surface of the protrusion and an inner surface of the groove. The plating layer may be formed of a material having a lower hardness than the first electrode terminal and the second electrode terminal. The first electrode terminal and the second electrode terminal may be formed of one of copper and aluminum or a combination thereof, and the plating layer may be formed of one of copper, gold, and silver or a combination thereof. A width or diameter of the protrusion may be greater than a width or diameter of the groove.

The protrusion and the groove may be respectively provided as four or more protrusions and four or more grooves, and the protrusions and the grooves may be disposed in a lattice form.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a schematic perspective view showing a configuration of a rechargeable battery module according to some embodiments of the present disclosure;

FIG. 2 is a schematic view showing an example of a rechargeable battery according to some embodiments of the present disclosure;

FIG. 3 is a schematic view showing another example of the rechargeable battery shown in FIG. 2 according to some embodiments of the present disclosure;

FIG. 4A is a schematic plan view showing a portion of an exemplary configuration of the rechargeable battery module according to some embodiments of the present disclosure;

FIG. 4B is a schematic plan view showing a portion of another exemplary configuration of a rechargeable battery module according to some embodiments of the present disclosure;

FIG. 5 is a schematic view showing an example of a coupled shape of electrode terminals according to some embodiments of the present disclosure;

FIG. 6A is a schematic plan view showing a portion of an exemplary configuration of a rechargeable battery module according to some embodiments of the present disclosure;

FIG. 6B is a schematic plan view showing a portion of an exemplary configuration of a rechargeable battery module according to some embodiments of the present disclosure;

FIGS. 7A and 7B are views showing components of a connecting structure of electrode terminals of the rechargeable battery shown in FIG. 6A or 6B in detail;

FIGS. 8A and 8B are schematic views showing an example of components of a connecting structure of the electrode terminals of the adjacent rechargeable battery according to some embodiments of the present disclosure;

FIGS. 9A and 9B are schematic views respectively showing components of an exemplary connecting structure and the connecting structure of the electrode terminals of adjacent rechargeable batteries according to some embodiments of the present disclosure;

FIG. 10 is a schematic plan view showing an example of a connecting structure formed by electrode terminals of adjacent rechargeable batteries according to some embodiments of the present disclosure; and

FIG. 11 is a schematic plan view showing a portion of an exemplary configuration of a rechargeable battery module according to some embodiments of the present disclosure.

### DETAILED DESCRIPTION

Hereinafter, embodiments of the present disclosure will be described in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

In addition, when used in the present specification, “comprise” and “include” and/or “comprising” and “including” specify the presence of the stated features, numbers, steps, operations, members, elements, and/or groups thereof and do not preclude the presence or addition of one or more other features, numbers, operations, members, elements, and/or groups thereof.

In addition, to facilitate understanding of the embodiments in the disclosure, the accompanying drawings are not drawn to scale, and dimensions of some components may be shown in an exaggerated manner. In addition, the same reference numbers may denote the same components in different embodiments.

When two compared objects are “the same,” it means that they are “substantially the same.” Accordingly, “substantially the same” may include a deviation that is considered low in the art, for example, a deviation within 5%. In addition, if a certain parameter is referred to as being uniform in a given region, it may mean that it is uniform in terms of an average thereof.

Although “first,” “second,” etc. are used to describe various components, these components are not limited by these terms. These terms are used only to distinguish one component from another, and unless otherwise stated, it is apparent that a first component may be a second component.

Throughout the specification, unless otherwise stated, each element may be singular or plural.

When any component is disposed “above (or below)” a component or “on (or under)” it may mean not only that any component is disposed in contact with an upper surface (or lower surface) of the above component, but also that other components may be interposed between the above component and any component disposed on (or under) the above component.

In addition, when a certain component is stated as being “on,” “connected to,” or “coupled to” another component, it should be understood not only that the components may be directly connected or joined, but that other components may be “interposed” between the components or that the components may be “connected,” “coupled,” or “joined” through another component.

As used herein, the term “and/or” includes any and all combinations of one or more of the associated items listed. In addition, the use of “may” when describing embodiments of the present disclosure relates to “one or more embodiments of the present disclosure.” Expressions, such as “at least one of” and “any one of,” before a list of elements, modify the entire list of elements and do not modify the individual elements of the list.

Throughout the specification, when “A and/or B” is stated, it means A, B or A and B, unless otherwise stated, and when “C to D” is stated, it means C or more and D or less, unless otherwise specified.

When phrases such as “at least one of A, B, and C, “at least one of A, B, or C,” “at least one selected from a group of A, B, and C,” or “at least one selected from among A, B, and C” are used to designate a list of elements A, B, and C, the phrase may refer to any and all suitable combinations thereof.

The term “use” may be considered synonymous with the term “utilize.” As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teaching of example embodiments.

Spatially relative terms, such as “beneath,” “below,” “lower,” “above,” “upper,” and the like, may be used herein for ease of description to describe a relationship of one element or feature to (an)other element(s) or feature(s) as illustrated in the figures. It will be understood that the spatially relative terms are intended to encompass different orientations of the device in use or operation in addition to the orientations depicted in the figures. For example, if a device in the figures is turned over, elements described as “below” or “beneath” other elements or features would then be oriented “above” or “over” the other elements or features. Thus, the term “below”may encompass both an orientation of above and below.

The terminology used herein is intended to describe embodiments of the present disclosure and is not intended to limit the present disclosure.

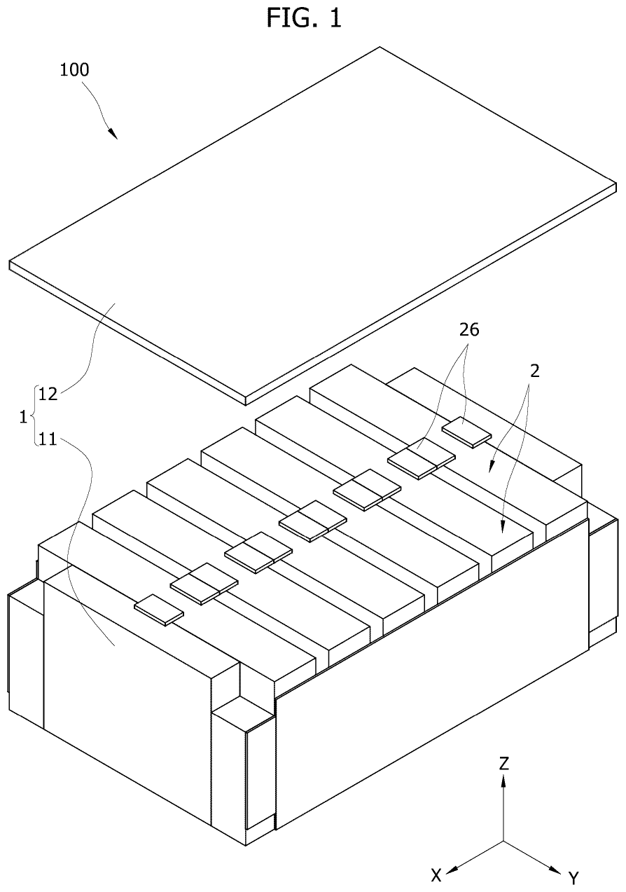

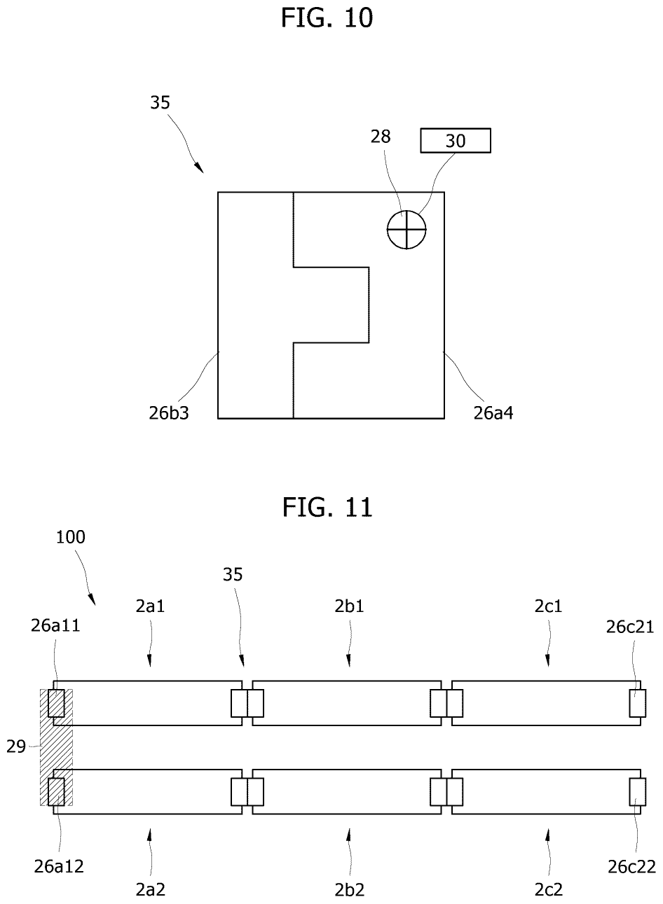

FIG. 1 is a schematic perspective view showing a configuration of a rechargeable battery module 100 according to some embodiments of the present disclosure. Referring to FIG. 1, the rechargeable battery module may include a housing 1 and a plurality of rechargeable batteries 2. In addition, although not shown in the drawing, the rechargeable battery module 100 may further include a protection circuit module 30 (FIG. 10) electrically connected to the rechargeable battery 2 to detect a state of the rechargeable battery 2, such as a voltage or temperature. There is no particular limitation to the type, specific configuration, or arrangement position of the protection circuit module.

The housing 1 may form the approximate appearance of the rechargeable battery module 100 and provide a space in which a plurality of rechargeable batteries 2 may be accommodated. According to one embodiment, the housing 1 may include a housing body 11 and a cover 12.

The housing body 11 may be formed to have a box shape with an empty interior and one open side. A cross-sectional shape of the housing body 11 is not limited to a quadrangular shape shown in FIG. 1 and may be changed in terms of design to have any of various shapes such as another polygonal, a circular, or an oval shape.

The cover 12 may be coupled to the housing body 11 to close an internal space of the housing body 11. For example, the cover 12 may be formed to have substantially a plate shape and disposed to face the open side of the housing body 11. The cover 12 may be fixed to the housing body 11 by various types of coupling methods such as bolting, welding, and fitting.

The rechargeable battery 2 may function as a unit structure that stores and supplies power in the rechargeable battery module. The rechargeable battery 2 may be disposed inside the housing 1. The number of rechargeable batteries 2 may be changed in terms of design in various ways depending on the size, shape, etc. of the housing 1.

A plurality of rechargeable batteries 2 may be included in the housing 1. The plurality of rechargeable batteries 2 may be arranged in a row in one of a longitudinal direction (X-axis direction based on FIG. 1) or a width direction (Y-axis direction based on FIG. 1) of the housing 1. Although FIG. 1 shows an example in which rechargeable batteries 2 are arranged in a row in the longitudinal direction of the housing 1, the arrangement form of the plurality of rechargeable batteries 2 is not limited thereto and may be changed in terms of design to have various forms. For example, inside the housing 1, two or more of the plurality of rechargeable batteries 2 arranged in a row in the longitudinal direction may be arranged side by side in a width direction, or two or more of the plurality of rechargeable batteries 2 arranged in a row in the width direction may be arranged side by side in the longitudinal direction.

The plurality of rechargeable batteries 2 may be electrically connected. According to the present embodiment, the plurality of rechargeable batteries 2 arranged in a row in one direction may be electrically connected through contact coupling between electrode terminals 26 of neighboring rechargeable batteries 2. Therefore, since the plurality of rechargeable batteries 2 may be electrically connected without using a busbar, charge/discharge loss due to impedance of the busbar can be prevented. In addition, since the busbar and/or a separate structure for fixing or supporting the busbar is not required, it is possible to simplify a configuration of a device of the rechargeable battery module and also reduce the weight of the rechargeable batteries 2. A detailed method of the contact coupling between the electrode terminals 26 according to some embodiments is described below.

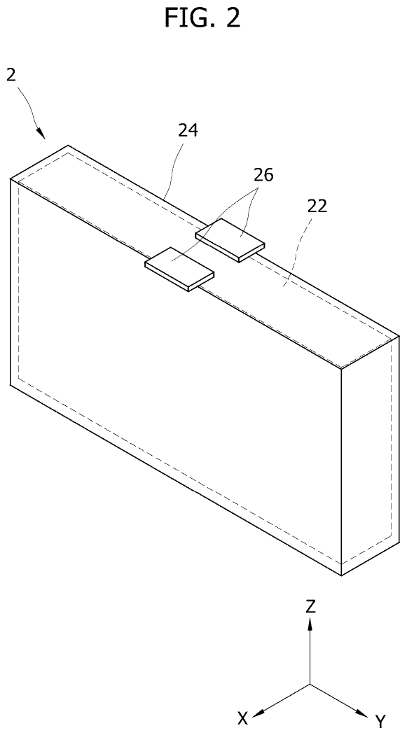

FIG. 2 is a schematic view showing an example of a rechargeable battery 2 according to some embodiments of the present disclosure. Referring to FIG. 2, the rechargeable battery 2 includes an electrode assembly 22, a case 24, and electrode terminals 26. The rechargeable battery 2 may be a prismatic rechargeable battery in which the electrode assembly 22 is accommodated inside the case 24 to charge and discharge a preset amount of power. However, the embodiments are not limited to the prismatic rechargeable battery and do not preclude application to other types of rechargeable batteries.

The electrode assembly 22 may be formed by winding or stacking a laminate of a first electrode plate (not shown), a separator (not shown), and a second electrode plate (not shown), which are formed in a sheet shape or a film shape. When the electrode assembly 22 is a wound laminate, a winding axis may be parallel to the longitudinal direction of the case 24. In addition, the electrode assembly 22 may be a stack type rather than the winding type, and the shape of the electrode assembly 22 is not limited in the present disclosure. In addition, the electrode assembly 22 may be a Z-stack electrode assembly in which a positive electrode plate and a negative electrode plate are inserted into both sides of a separator bent into a Z-stack. The first electrode plate of the electrode assembly 22 may function as a negative electrode, and the second electrode plate may function as a positive electrode. The reverse thereof is also possible.

The first electrode plate may be formed by coating a first electrode current collector formed of a metal foil, such as copper, a copper alloy, nickel, or a nickel alloy with a first electrode active material, such as graphite or carbon and may include a first electrode tab (or a first uncoated portion) that is a region which is not coated with the first electrode active material.

The first electrode active material applied on the first electrode plate that functions as a positive electrode may include a positive electrode active material. The positive electrode active material may be a compound capable of reversible intercalation and deintercalation of lithium (a lithiated intercalation compound). More specifically, as the positive electrode active material, one or more of composite oxides of a metal selected from the group consisting of cobalt, manganese, nickel, iron, and a combination thereof and lithium may be used.

As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). Here, 0<x<1, 0<y<1, 0<z<1, and x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM) or include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM).

The first electrode tab may be a passage for a current flow between the first electrode plate and the first current collector. In some examples, the first electrode tab may be formed by cutting the first electrode plate in advance to protrude to one side when the first electrode plate is manufactured or may protrude further to one side than the separator without separate cutting being performed.

The second electrode plate may be formed by coating a second electrode current collector formed of a metal foil, such as aluminum or an aluminum alloy with a second electrode active material, such as a transition metal oxide, and may include a second electrode tab (or a second uncoated portion) that is a region which is not coated with the second electrode active material.

The second electrode active material applied on the second electrode plate that functions as a negative electrode may include a negative electrode active material. The negative electrode active material may include a material capable of reversible intercalation/deintercalation of lithium ions, a lithium metal, a lithium metal alloy, a material capable of doping and dedoping of lithium, or a transition metal oxide.

The material capable of reversibly intercalating/deintercalating lithium ions may be a carbon-based negative electrode active material, which may include, for example, crystalline carbon, amorphous carbon, or a combination thereof. An example of crystalline carbon may include graphite such as amorphous, plate-like, flake-like, spherical, or fiber-like natural graphite or artificial graphite, and examples of amorphous carbon may include soft carbon, hard carbon, mesophase pitch carbide, calcined coke, etc.

As the lithium metal alloy, an alloy of lithium and a metal selected from Na, K, Rb, Cs, Fr, Be, Mg, Ca, Sr, Si, Sb, Pb, In, Zn, Ba, Ra, Ge, Al, and Sn may be used.

As a material capable of doping and dedepoing of lithium, a Si-based negative electrode active material or a Sn-based negative electrode active material may be used. The Si-based negative electrode active material may be silicon, a silicon-carbon composite, SiOₓ (0<x≤2), a Si-Q alloy (Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SnO₂, a Sn-based alloy, or a combination thereof.

The silicon-carbon composite may be a composite of silicon and amorphous carbon. According to one embodiment, the silicon-carbon composite may be in the form of silicon particles and amorphous carbon coated on surfaces of the silicon particles. For example, the silicon-carbon composite may include a secondary particle (core) in which primary silicon particles are aggregated and an amorphous carbon coating layer (shell) located on a surface of the secondary particle. The amorphous carbon may be located between the primary silicon particles, for example, so that the primary silicon particles may be coated with amorphous carbon. The secondary particles may be present by being dispersed in an amorphous carbon matrix.

The silicon-carbon composite may further include crystalline carbon. For example, the silicon-carbon composite may include a core including crystalline carbon and silicon particles and an amorphous carbon coating layer on the surface of the core.

The Si-based negative electrode active material or Sn-based negative electrode active material may be used in combination with a carbon-based negative electrode active material.

The second electrode tab may be a passage for a current flow between the second electrode plate and the second current collector. In some examples, the second electrode tab may be formed by cutting the second electrode plate in advance to protrude to the other side when the second electrode plate is manufactured or may protrude further to the other side than the separator without separate cutting being performed.

In some examples, the first electrode tab may be positioned on a side surface of a left end of the electrode assembly 22, the second electrode tab may be positioned on a side surface of a right end of the electrode assembly 22, or the first electrode tab and the second electrode tab may be positioned on one surface in the same direction. Here, the left and right sides are for the sake of convenience of description based on the rechargeable battery 2 shown in FIG. 2, and their positions may be changed when the rechargeable battery 2 rotates horizontally or vertically.

The first electrode tab of the first electrode plate and the second electrode tab of the second electrode plate are each positioned at one of both end portions of the electrode assembly 22. In some examples, the electrode assembly may be accommodated in the case together with an electrolyte. In addition, the electrode assembly 22 is positioned by welding and bonding the first electrode tab of the first electrode plate and the second electrode tab of the second electrode plate, which are exposed at both sides, to the first current collector and the second current collector, respectively.

The case 24 may form an approximate appearance of the rechargeable battery 2 and may be formed to have a rectangular parallelepiped shape that is hollow to accommodate the electrode assembly 22. Although not shown in the drawing, the case 24 may have an additional structure installed to support and/or fix the electrode assembly 22 accommodated therein. A vent (not shown) that opens as an internal pressure of the case 24 increases may be formed on an upper surface of the case 24.

A pair of electrode terminals 26 are provided in the rechargeable battery 2. One of the pair of electrode terminals 26 may be electrically connected to the positive electrode of the electrode assembly 22 and, for example, may be directly connected to the first electrode tab or connected to the first electrode tab through a conductive member such as a tab lead. In addition, the other electrode terminal 26 may be electrically connected to the negative electrode of the electrode assembly 22 and, for example, may be directly connected to the second electrode tab or connected to the second electrode tab through a conductive member such as a tab lead.

The pair of electrode terminals 26 may be installed on the upper surface of the case 24 having a rectangular parallelepiped shape, as shown. More specifically, the pair of electrode terminals 26 may each be installed at one of facing long sides of the upper surface of the case 24. For example, as shown in FIG. 2, the electrode terminals 26 may be arranged to face each other at the center of the two long sides. However, the present embodiment is not limited thereto, and when the pair of electrode terminals 26 are positioned to face each other, the electrode terminals 26 may be disposed at random positions at the two long sides. In this case, in the rechargeable battery module 100, a front portion of one of the two adjacent rechargeable batteries 2 is arranged to face a rear portion of the other rechargeable battery 2 (see FIG. 1).

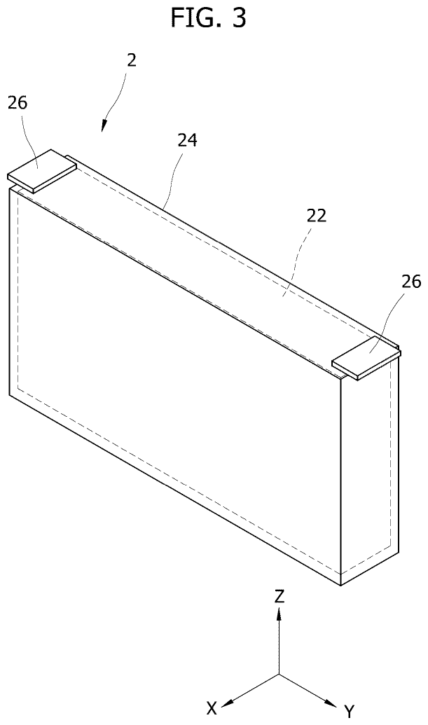

FIG. 3 is a schematic view showing an exemplary embodiment of the rechargeable battery 2 according to some embodiments of the present disclosure. In contrast to FIG. 2, the rechargeable battery shown in FIG. 3 has a difference in the arrangement positions of the electrode terminals 26 when viewed from the exterior. According to some embodiments, an arrangement direction of components constituting the electrode assembly 22 and/or their connection relationship may vary depending on the arrangement positions of the electrode terminals 26.

Referring to FIG. 3, the pair of electrode terminals 26 may each be installed at one of facing short sides of the upper surface of the case 24. For example, the electrode terminals 26 may be arranged to face each other at the center of the short sides. However, the present embodiment is not limited thereto, and when the pair of electrode terminals 26 are positioned to face each other, the electrode terminals 26 may be disposed at random positions at the two short sides. In this case, the rechargeable battery module 100 is arranged so that a left side surface of one of two adjacent rechargeable batteries 2 faces a right side surface of the other rechargeable battery 2.

According to exemplary embodiments, the electrode terminals 26 installed at the long sides (as in FIG. 2) or short sides (as in FIG. 3) of the upper surface of the case 24 may be installed by being fixed or bonded to the upper surface of the case 24 through bottom surfaces thereof. For example, the electrode terminals 26 may have a substantially rectangular parallelepiped shape. In this case, the electrode terminal 26 may be installed by being fixed or bonded to the upper surface of the case 24 through a portion of the bottom surface thereof. In addition, the electrode terminal 26 may be installed on the upper surface of the case 24 so that portions thereof protrude outward from the case 24.

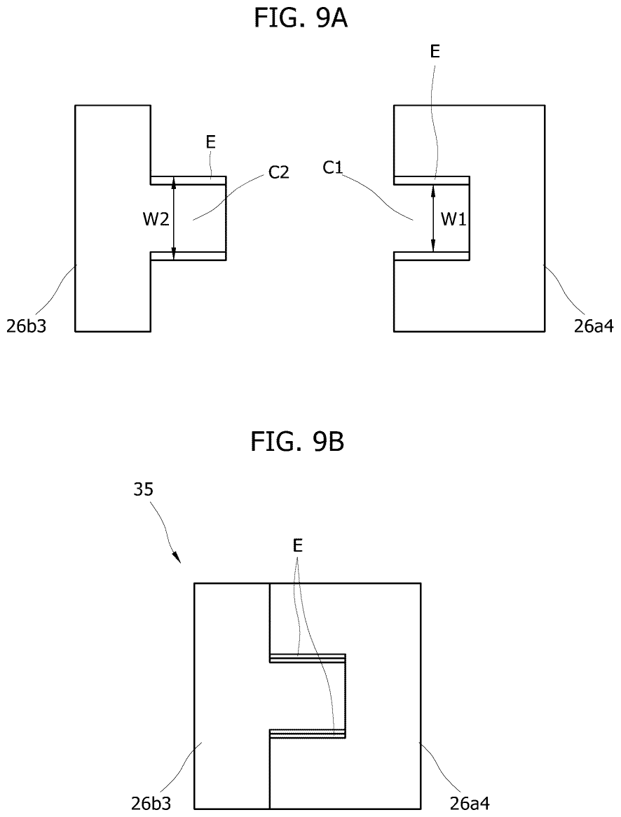

In exemplary embodiments, the electrode terminals 26 may have a predetermined shape to form a connecting structure 35 (see e.g., FIG. 9B) with one electrode terminal 26 (of one rechargeable battery 2) being coupled to the other electrode terminal 26 (of another rechargeable battery 2). In this case, the electrode terminal 26 may be installed by being fixed or bonded to the upper surface of the case 24 through the entirety or a portion of the bottom surface thereof. In this case, a portion of the electrode terminal 26 forming the connecting structure 35 may protrude outward from the case 24. A detailed example of the connecting structure 35 is described below.

Next, some embodiments of the contact coupling between the electrode terminals 26 of two adjacent rechargeable batteries 2 in the rechargeable battery module 100 are described.

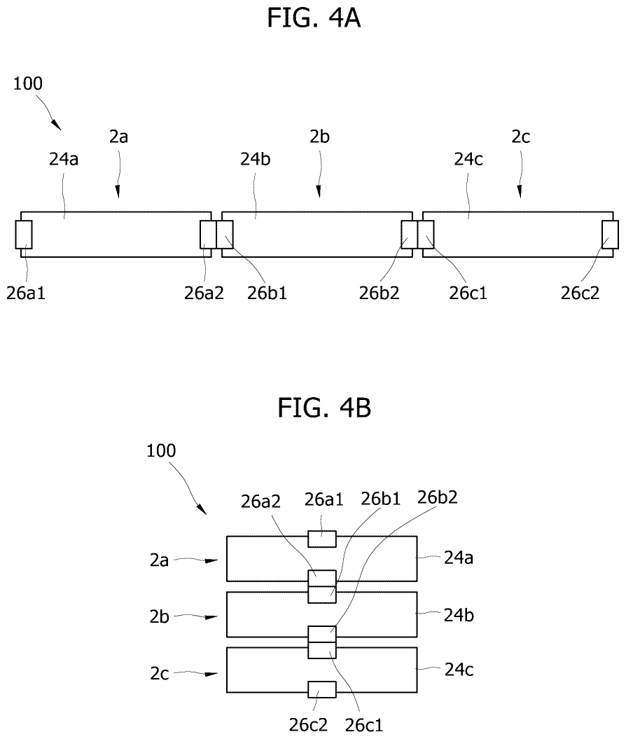

FIGS. 4A and 4B are schematic plan views each showing a portion of a configuration of a rechargeable battery module 100 according to some embodiments of the present disclosure and show a configuration of a portion of the rechargeable battery module 100 of FIG. 1 (three rechargeable batteries 2a, 2b, and 2c arranged in a row in the X-axis direction) in a top view (in the Z-axis direction). Here, the rechargeable batteries 2a, 2b, and 2c constituting the rechargeable battery module 100 of FIG. 4A may each be the rechargeable batteries 2 of FIG. 3, and the rechargeable batteries 2a, 2b, and 2c constituting the rechargeable battery module 100 of FIG. 4B may each be the rechargeable batteries 2 of FIG. 2. In addition, electrode terminals 26a1, 26a2, 26b1, 26b2, 26c1, and 26c2 of the rechargeable batteries 2a, 2b, and 2c are shown to have a substantially rectangular hexahedron shape, but are not limited thereto.

Referring to FIGS. 4A and 4B, two adjacent rechargeable batteries 2 constituting the rechargeable battery module 100, for example, the rechargeable battery 2a and the rechargeable battery 2b, are electrically connected through direct contact between the electrode terminals 26a2 and 26b1 installed at short sides (in FIG. 4A) or long sides (in FIG. 4B) of upper surfaces of the cases 24a and 24b, respectively. In addition, the rechargeable battery 2b and the rechargeable battery 2c are electrically connected through direct contact between the electrode terminals 26b2 and 26c1 installed at the short sides or the long sides of the upper surfaces of the cases 24b and 24c, respectively. Here, “direct contact” refers to physical and electrical contact between the electrode terminals 26a2 and 26b1 (or 26b2 and 26c1) without the mediation of another structure (e.g., a busbar).

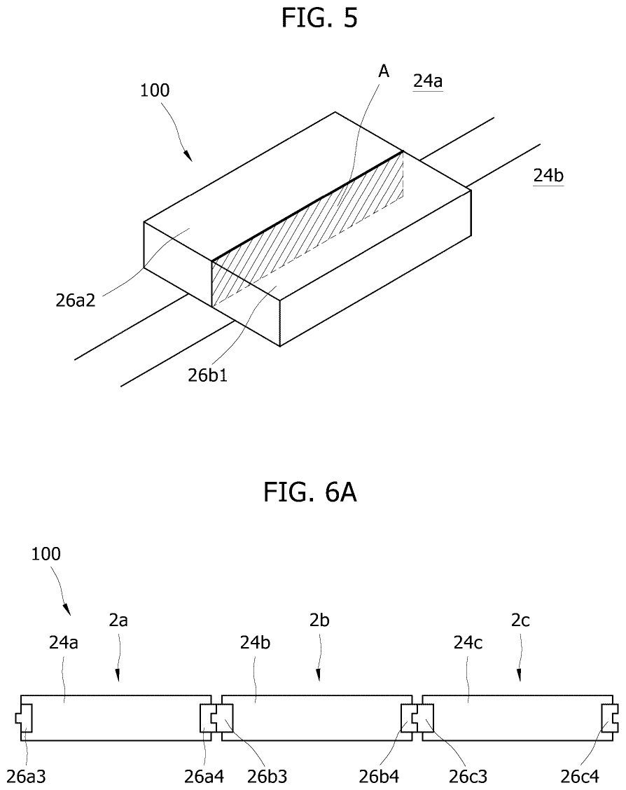

FIG. 5 is a schematic view showing an example of a coupled shape of electrode terminals 26 according to some embodiments of the present disclosure. The exemplary electrode terminals 26a2, 26b1 shown in FIG. 5 may be coupled through direct contact according to the embodiments discussed with reference to FIG. 4A or FIG. 4B.

Referring to FIG. 5, since an outer surface of the electrode terminal 26a2 (first electrode terminal) comes into direct contact with an outer surface of the electrode terminal 26b1 (second electrode terminal), the first electrode terminal 26a2 is coupled to the second electrode terminal 26b1. More specifically, since the outer surface of the first electrode terminal 26a2, that is, the outer surface facing the second electrode terminal 26b1, comes into direct contact with the outer surface of the second electrode terminal 26b1, that is, the outer surface facing the first electrode terminal 26a2, to form a contact portion A, the first electrode terminal 26a2 is coupled to the second electrode terminal 26b1.

Therefore, since the first electrode terminal 26a2 and the second electrode terminal 26b1 are coupled through surface contact between their relatively wide surfaces, it is possible to suppress an increase in impedance at the contact portion A and also improve coupling reliability. In addition, since the outer surfaces, which face each other, of the electrode terminals 26a2 and 26b1 come into direct contact with each other to form the contact portion A, for example, in comparison to a case in which an upper surface and a lower surface are coupled by being in contact with each other, it is possible to minimize a distance between the cases 24a and 24b while relatively increasing a contact area of the contact portion A, thereby suppressing an increase in size of the rechargeable battery module 100 including the plurality of rechargeable batteries 2 arranged in a row in one direction.

According to one aspect of the present embodiment, the first electrode terminal 26a2 and the second electrode terminal 26b1 may be bonded by welding at the contact portion A. Here, the welding may be line welding that performs bonding along an outer edge (outer line) of some or all of contact portion A, in which the first electrode terminal 26a2 comes into contact with the second electrode terminal 26b1, or surface welding performed on a surface of the contact portion A. The line welding may be performed on only a portion of the outer line (e.g., an outer line (thick solid line) on an upper surface of the contact portion A) or on the entire outer line having a quadrangular shape. The surface welding may be performed by instantaneously applying heat to the surface of the contact portion A.

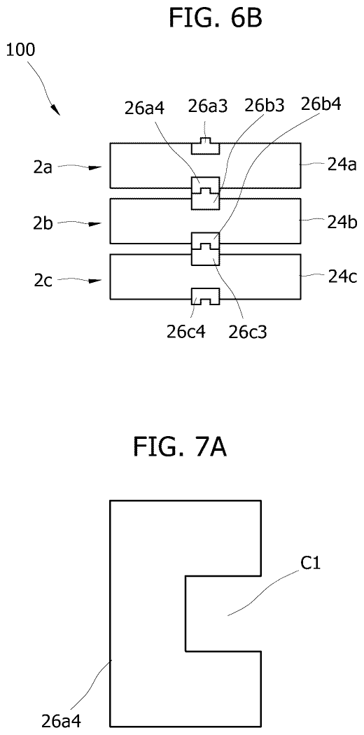

FIGS. 6A and 6B are schematic plan views each showing a portion of a configuration of a rechargeable battery module 100 according to some embodiments of the present disclosure and may show a configuration of a portion of the rechargeable battery module 100 of FIG. 1 (three rechargeable batteries 2a, 2b, and 2c arranged in a row in the X-axis direction) in a top view (in the Z-axis direction).

When viewed laterally at positions at which the electrode terminals 26a3, 26a4, 26b3, 26b4, 26c3, and 26c4 are installed, the rechargeable batteries 2a, 2b, and 2c constituting the rechargeable battery module of FIG. 6A may each correspond to the rechargeable battery 2 of FIG. 3, and the rechargeable batteries 2a, 2b, and 2c constituting the rechargeable battery module of FIG. 6B may each correspond to the rechargeable battery 2 of FIG. 2. However, in comparison to the embodiments described above with reference to FIGS. 4A, 4B, and 5, there is a difference in the shape of the electrode terminals 26a3, 26a4, 26b3, 26b4, 26c3, and 26c4 and their coupling methods, which is described below. Aspects that are not described in detail may be applied in a manner that is the same as or similar to embodiments described above with reference to FIGS. 4A, 4B, and 5.

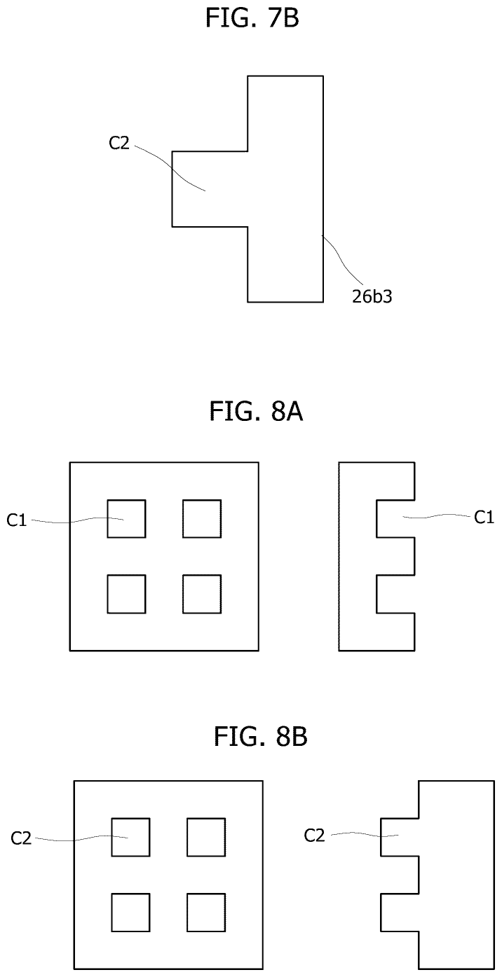

According to exemplary embodiments, a pair of coupled electrode terminals 26, for example, the electrode terminal 26a4 and the electrode terminal 26b3, have complementary shapes so that a predetermined connecting structure 35 in a coupled state is formed. “Connecting structure” refers to the pair of electrode terminals 26a4 and 26b3 having corresponding shapes or complementary shapes so that the shape of electrode terminal 26a4 complements (e.g., fits with) the shape of the electrode terminal 26b3. The connecting structure 35 includes a contact portion where the protrusion C2 contacts the groove C1, as shown in FIGS. 7A and 7B, for example, at which the electrode terminal 26a4 is in contact with the electrode terminal 26b3, and through the contact portion, the electrode terminal 26a4 and the electrode terminal 26b3 may be electrically connected.

According to exemplary embodiments, when the two electrode terminals 26a4 and 26b3 form the connecting structure 35, there is no particular limitation to the specific type of complementary shape forming the connecting structure 35. However, since the electrode terminals 26a4 and the electrode terminals 26b3 are coupled by forming the connecting structure 35, the physical coupling between the two electrode terminals 26a4 and 26b3 is further reinforced, and as a result, it is possible to suppress the two electrode terminals 26a4 and 26b3 from being separated by an external impact, thermal stress, etc.

FIGS. 7A and 7B each show an example of a “complementary shape.” More specifically, as shown in FIG. 7A, among the pair of electrode terminals 26a4 and 26b3 that come into direct contact with each other, an outer surface of the electrode terminal 26a4 (first electrode terminal) has a groove C1 (concave portion). In addition, as shown in FIG. 7B, an outer surface of the electrode terminal 26b3 (second electrode terminal) may include a protrusion C2 (convex portion). The protrusion C2 of the second electrode terminal 26b3 corresponding to the groove C1 of the first electrode terminal 26a4 may be inserted into the groove C1 to form the connecting structure 35.

According to exemplary embodiments, there is no particular limitation to the detailed shape of the protrusion C2. For example, the protrusion C2 may have a shape of a polygonal pillar, such as a quadrangular pillar, or a circular pillar. As another example, the protrusion C2 may have a cone shape, such as a quadrangular cone or a circular cone, or a truncated cone shape, such as a quadrangular truncated cone or a truncated cone. The shape of the groove C1 may correspond to the shape of the protrusion C2.

In addition, according exemplary embodiments, the number of protrusions C2 does not necessarily need to be one and may be two or more. In a case in which a plurality of protrusions C2 are present, there is no particular limitation to the arrangement form. For example, two protrusions C2 may be disposed side by side in a vertical or horizontal direction or disposed in a diagonal direction. The number and arrangement of the grooves C1 may correspond to the number and arrangement of the protrusions C2.

FIGS. 8A and 8B are schematic views showing an example of components of a connecting structure 35 of the electrode terminals 26 of adjacent rechargeable batteries 2 according to some embodiments of the present disclosure and each show a case in which four grooves C1 and complementary protrusions C2 are present. Here, FIG. 8A is a front view and a side view of four grooves C1, and FIG. 8B is a front view and a side view of four protrusions C2. Referring to FIGS. 8A and 8B, the four protrusions C2 each having a quadrangular pillar shape are disposed in a grid shape, and correspondingly, the four grooves C1 each having a quadrangular pillar shape are also disposed in a grid shape. According to such a connecting structure 35, in comparison to the connecting structure 35 (e.g., electrode terminals 26a4 and 26b3, electrode terminals 26b4 and 26c3) shown in FIG. 6A or 6B, that is, the connecting structure 35 formed by one protrusion C2 and one groove C1, the physical coupling between the two electrode terminals 26a4 and 26b3 may be further reinforced.

FIGS. 9A and 9B are schematic views respectively showing components of an exemplary connecting structure 35 and the connecting structure 35 of the electrode terminals 26 of adjacent rechargeable batteries 2 according to some embodiments of the present disclosure. FIG. 9A shows the second electrode terminal 26b3 having the protrusion C2 and the first electrode terminal 26a4 having the groove C1, and FIG. 9B shows a case in which the second and first electrode terminals 26b3, 26a4 are coupled to form the connecting structure 35. Although FIGS. 9A and 9B show the configuration in which the first and second electrode terminals 26a4 and 26b3 each have one groove C1 or one protrusion C2, respectively, the discussion herein applies, as well, to configurations in which the second and first electrode terminals 26b3 and 26a4 each have two or more protrusions C2 and grooves C1, respectively.

Referring to FIGS. 9A and 9B, each of the protrusion C2 and the groove C1 may further include a plating portion E formed of a predetermined metal material on part of the contact surface. That is, the plating portion E may be formed on some or all of a surface of one or both electrode terminals 26 forming a connecting structure 35. More specifically, as shown in FIG. 9A, the plating portion E may be formed on a portion of each of a surface (e.g., an inner surface) of the groove C1 and a surface (e.g., an outer surface) of the protrusion C2. As in the exemplary illustration in FIG. 9A, the plating portion E may be formed of a predetermined thickness on a portion of the surface of the groove C1 and/or a portion of the surface of the protrusion C2 parallel to a connecting direction of the first and second electrode terminals 26a4 and 26b3. As a result, as shown in FIG. 9B, when the protrusion C2 of the second electrode terminal 26b3 is coupled by being inserted into the groove C1 of the first electrode terminal 26a4, the plating portion E may be disposed on a contact interface (i.e., contact surface) between the groove C1 and the protrusion C2.

According to exemplary embodiments, the plating portion E may be formed of a material having a lower hardness than a material forming the second and first electrode terminals 26b3 and 26a4 (e.g., terminal portions thereof). For example, when the second and first electrode terminals 26b3 and 26a4 (e.g., the terminal portions thereof) are formed of copper (Cu), aluminum (Al), or an alloy thereof, the plating portion E may be formed of a material having a lower hardness than the terminal portion, such as copper (Cu), gold (Au), silver (Ag), or an alloy thereof. Therefore, when the protrusion C2 of the second electrode terminal 26b3 is coupled by being inserted into the groove C1 of the first electrode terminal 26a4, the plating portion E may be pressed by friction, thereby increasing the contact strength between the second electrode terminal 26b3 and the first electrode terminal 26a4.

In this case, a diameter or width W2 of the protrusion C2 of the second electrode terminal 26b3 may be greater than a diameter or width W1 of the groove C1 of the first electrode terminal 26a4. Therefore, when the protrusion C2 of the second electrode terminal 26b3 is coupled by being inserted into the groove C1 of the first electrode terminal 26a4, the plating portion E may be further pressed, thereby increasing the contact strength between the second electrode terminal 26b3 and the first electrode terminal 26a4.

The extent to which the width W2 of the protrusion C2 is greater than the width W1 of the groove C1 is not particularly limited, but while the second electrode terminal 26b3 is coupled to the first electrode terminal 26a4, the protrusion C2 at least needs to be inserted into the groove C1. As such, a size difference does not need to be so great that insertion of the protrusion C2 into the groove C1 is inhibited. More specifically, the size difference between the width W2 of the protrusion C2 and the width W1 of the groove C1 is preferably smaller than the thickness of the plating portion E. In exemplary embodiments, the size difference between the width W2 of the protrusion C2 and the width W1 of the groove C1 may be 1 mm or less, preferably, 0.5 mm or less. For example, when the thickness of the plating portion E is 0.2 mm, the width W2 of the protrusion C2 may be 5.1 mm, and the diameter or width W1 of the groove C1 may be 5.0 mm.

According to exemplary embodiments, the second electrode terminal 26b3 and the first electrode terminal 26a4 may be bonded by welding at the contact portion. Here, the welding may be line welding, as previously discussed, that performs bonding along an outer edge portion (outer line) of the portion in which the second electrode terminal 26b3 comes into contact with the first electrode terminal 26a4. The line welding may be performed on only a portion of the outer line or on the entire line.

FIG. 10 is a schematic plan view showing an example of a connecting structure 35 formed by electrode terminals 26 of adjacent rechargeable batteries 2 according to some embodiments. Referring to FIG. 10, at least one of the electrode terminals 26a4 and 26b3, which form the connecting structure 35, of the adjacent rechargeable batteries 2 is further provided with a connecting portion 28. The connecting portion 28 is a portion electrically connected to a protection circuit module 30 (e.g., sensor) for detecting a state of the rechargeable battery 2, such as a voltage or temperature, including the electrode terminals 26a4 and 26b3.

For example, at the connecting portion 28, a ring terminal coupled to an end portion of a wire electrically connected to the protection circuit module 30 may be fastened to the electrode terminals 26a4 and 26b3 by bolts. To this end, a hole may be formed in one of the electrode terminals 26a4 and 26b3 into which bolts may be fastened. As another example, at the connecting portion 28, a ring terminal or a terminal connected to an end portion of a wire electrically connected to the protection circuit module 30 may be bonded to the electrode terminals 26a4 and 26b3 through welding such as rivet welding.

FIG. 11 is a schematic plan view showing a portion of an exemplary configuration of a rechargeable battery module 100 according to some embodiments of the present disclosure. The rechargeable battery module shown in FIG. 11 includes two sets of the three rechargeable batteries 2a, 2b, and 2c included in the rechargeable battery module of FIG. 4A. However, embodiments conforming to the description herein are not limited to the numbers or arrangement shown in FIG. 11. For example, the description herein may apply to a case in which three or more sets of the three rechargeable batteries 2a, 2b, and 2c are included or, more generally, a case in which two or more sets of two or more rechargeable batteries 2 are included in the rechargeable battery module 100 arranged according to the exemplary embodiments discussed with reference to FIGS. 4A and 4B. In addition, exemplary embodiments may be applied to a rechargeable battery module 100 including the connecting structure 35 resulting from components shown in FIGS. 6A and 6B.

Referring to FIG. 11, the exemplary rechargeable battery module 100 includes six rechargeable batteries arranged in a 3×2 form. More specifically, the rechargeable battery module includes three rechargeable batteries 2a1, 2b1, and 2c1 disposed in a row in a horizontal direction (a first direction) and three rechargeable batteries 2a2, 2b2, and 2c2, which are adjacent to the three rechargeable batteries 2a1, 2b1, and 2c1, also disposed in a row in the horizontal direction (the first direction). According to the exemplary illustration, the three rechargeable batteries 2a1, 2b1, and 2c1 and the three rechargeable batteries 2a2, 2b2, and 2c2 are electrically connected, respectively, as shown in FIG. 4A.

In addition, according to exemplary embodiments, the rechargeable battery module 100 may further include a partial busbar 29 for electrically connecting the vertically adjacent sets of rechargeable batteries 2. More specifically, the partial busbar 29 may be for electrically connecting the three rechargeable batteries 2a1, 2b1, and 2c1 to the three rechargeable batteries 2a2, 2b2, 2c2 via electrode terminals 26a11 and 26a12 of the two rechargeable batteries 2a1, 2a2 positioned at the far left among the two sets of three rechargeable batteries 2a1, 2b1, 2c1, and 2a2, 2b2, 2c2. That is, the rechargeable battery 2a1 (first rechargeable battery) and the rechargeable battery 2a2 (third rechargeable battery) are electrically connected via the partial busbar 29. Alternatively, the partial busbar 29 may also be installed to electrically connect the three rechargeable batteries 2a1, 2b1, 2c1 to the three rechargeable batteries 2a2, 2b2, 2c2 via electrode terminals 26c21 and 26c22 of the two rechargeable batteries 2c1 and 2c2 positioned at the far right among the two sets of three rechargeable batteries 2a1, 2b1, 2c1 and 2a2, 2b2, 2c2.

Based on the partial busbar 29, two electrode terminals 26 that are disposed on opposite ends in a protruding direction, such as the electrode terminals 26a11 or 26c22, and thus are not easily connected through contact coupling between the electrode terminals 26a11 and 26c22, for example, may still be electrically connected via two vertically adjacent electrode terminals 26 such as the electrode terminals 26a11 and 26a12, as shown in FIG. 11. According to the present disclosure, a rechargeable battery module 100 that may suppress the occurrence of charge/discharge loss can be provided by electrically connecting a plurality of rechargeable batteries 2 without using a busbar.

Effects of the present disclosure are not limited to those described above, and other effects that are not specifically mentioned herein will be clearly understood by those skilled in the art based on the description of the present disclosure.

Although the present disclosure has been described above with respect to embodiments and drawings illustrating aspects thereof, the present disclosure is not limited thereto. Various modifications and variations can be made thereto by those skilled in the art within the scope of the present disclosure and the appended claims and their equivalents.

What is claimed is:

1. A rechargeable battery module comprising:
a first rechargeable battery including a first electrode terminal; and
a second rechargeable battery including a second electrode terminal and disposed adjacent to the first rechargeable battery,
wherein the first electrode terminal and the second electrode terminal are coupled through at least a contact portion at which an outer surface of the first electrode terminal facing the second electrode terminal is in contact with an outer surface of the second electrode terminal facing the first electrode terminal.

2. The rechargeable battery module of claim 1, wherein the first electrode terminal and the second electrode terminal are bonded by welding at the contact portion.

3. The rechargeable battery module of claim 2, wherein, at the contact portion, a part or entirety of an outer line of the contact portion is bonded by line welding or a contact surface of the contact portion is bonded by surface welding.

4. The rechargeable battery module of claim 1, wherein the first electrode terminal has a first shape, and the second electrode terminal has a second shape complementary to the first shape, and
the first shape and the second shape are coupled to form a connecting structure including the contact portion.

5. The rechargeable battery module of claim 4, wherein the first shape includes a groove recessed in a portion of the outer surface of the first electrode terminal, and the second shape includes a protrusion protruding from a portion of the outer surface of the second electrode terminal, and
the connecting structure is formed by inserting the protrusion into the groove.

6. The rechargeable battery module of claim 5, wherein a plating layer is further disposed on at least a portion of a contact interface of the protrusion and the groove.

7. The rechargeable battery module of claim 6, wherein the plating layer is formed of a material having a lower hardness than the first electrode terminal and the second electrode terminal.

8. The rechargeable battery module of claim 7, wherein the first electrode terminal and the second electrode terminal are formed of one of copper and aluminum or a combination thereof, and the plating layer is formed of one of copper, gold, and silver or a combination thereof.

9. The rechargeable battery module of claim 5, wherein the protrusion and the groove are respectively provided as one protrusion and one groove or two or more protrusions and two or more grooves.

10. The rechargeable battery module of claim 9, wherein the protrusion and the groove are respectively provided as four or more protrusions and four or more grooves, and the protrusions and the grooves are disposed in a lattice form.

11. The rechargeable battery module of claim 1, wherein the first electrode terminal is fixed to an upper surface of a first case that accommodates an electrode assembly of the first rechargeable battery and protrudes to one side,
the second electrode terminal is fixed to an upper surface of a second case that accommodates an electrode assembly of the second rechargeable battery and protrudes to one side, and
protruding portions of the first electrode terminal and the second electrode terminal are coupled.

12. The rechargeable battery module of claim 1, further comprising:
a protection circuit module that detects states of the first rechargeable battery and the second rechargeable battery; and
a connecting portion provided on at least one of the first electrode terminal and the second electrode terminal and electrically connected to the protection circuit module.

13. The rechargeable battery module of claim 1, wherein the first rechargeable battery further includes a third electrode terminal, and
the rechargeable battery module further includes:
a third rechargeable battery disposed in a different direction from an arrangement direction of the first rechargeable battery and the second rechargeable battery and including a fourth electrode terminal; and
a partial busbar electrically connecting the third electrode terminal to the fourth electrode terminal.

14. A rechargeable battery comprising:
an electrode assembly;
a case having a rectangular parallelepiped shape, which accommodates the electrode assembly; and
a pair of terminals electrically connected to the electrode assembly and installed on an outer surface of the case so that portions thereof protrude from the case,
wherein the pair of terminals include a first electrode terminal having a first shape, and a second electrode terminal having a second shape complementary to the first shape, and
the first electrode terminal and the second electrode terminal are each installed at opposite sides of the outer surface of the case.

15. The rechargeable battery of claim 14, wherein the first shape includes a protrusion protruding from a portion of an outer surface of the first electrode terminal, and the second shape includes a groove recessed in a portion of an outer surface of the second electrode terminal, and
the protrusion forms a connecting structure by being inserted into a groove of a rechargeable battery disposed adjacent to the rechargeable battery.

16. The rechargeable battery of claim 15, further comprising a plating layer formed on at least one of an outer surface of the protrusion and an inner surface of the groove.

17. The rechargeable battery of claim 16, wherein the plating layer is formed of a material having a lower hardness than the first electrode terminal and the second electrode terminal.

18. The rechargeable battery of claim 17, wherein the first electrode terminal and the second electrode terminal are formed of one of copper and aluminum or a combination thereof, and the plating layer is formed of one of copper, gold, and silver or a combination thereof.

19. The rechargeable battery of claim 17, wherein a width or diameter of the protrusion is greater than a width or diameter of the groove.

20. The rechargeable battery of claim 15, wherein the protrusion and the groove are respectively provided as four or more protrusions and four or more grooves, and the protrusions and the grooves are disposed in a lattice form.
